(19) United States
(12) Patent Application Publication
(10) Pub. No.: US 2002/0097151 A1
(43) Pub. Date: Jul. 25, 2002

(54) Security device particularly suitable for valuables cases

(76) Inventors: Felice Lavecchia, Zevio (Verona) (IT); Giorgio Melotti, Grezzana (Verona) (IT)

Correspondence Address: R. Neil Sudol, Coleman Sudol Sapone, P.C., 714 Colorado Avenue, Bridgeport, CT, 06605-1601, US

(21) Appl. No.: 10/052,714

(22) Filed: Jan. 18, 2002

(30) Foreign Application Priority Data
Jan. 19, 2001 (IT) VR2001A000007

(51) Int. Cl. H04B 1/00

(52) U.S. Cl. 340/568.1; 340/5.3; 340/5.73

(57) ABSTRACT

A security device particularly suitable for a valuables case, having at least one electric power source and alarm system electrically connected to said power source, and comprising at least one light-responsive means that is installed in a valuables case and is energized by the said electric power source upon control and by a change in environment lighting conditions, whereby generating at least one control signal for energizing the said alarm system.

### DESCRIPTION

The present invention relates to a security device particularly, but not exclusively, suitable for portable valuables cases, e.g. those used for jewellery, cash and the like.

As known, some cases of jewellery theft, even of jewellery of substantial monetary value, take place in jewellers' shops when the jewellery is taken out of the safe in either their rigid or flexible (roll-up) cases and placed on the counter to be displayed for examination by the potential customer. The thief usually asks to view several cases and then, using some stratagem to distract the shopkeeper, grabs a case, such as a roll-up case, hides it in his clothing that is usually loose and has suitably prepared pockets, and then makes his getaway almost always without being stopped. When the shopkeeper becomes aware that the goods are missing it is too late.

The main object of the present invention is to provide a security device suitable for preventing or exposing the thief immediately and if necessary track him.

Another object of the present invention is to provide an easily hidden security device that is highly effective and that has relatively low production costs,

These and other objects that will be better appear below, are achieved by a security device particularly suitable for valuables cases, having at least one electric power source and alarm system, characterised in that it comprises at least one light-responsive means that is installed in a valuables case and can be energized by the said electric power source upon control and by a change in environment lighting conditions, whereby generating at least one control signal for energizing the said alarm system.

Advantageously, a security device according to the present invention for a valuables case comprises a satellite transmitter connected to said electric power source and remote control device arranged to energize the said satellite transmitter

Further aspects and advantages of the present invention will better appear from the following description of some embodiments thereof given merely by way of non-limiting examples, with reference to the accompanying drawings, in which:

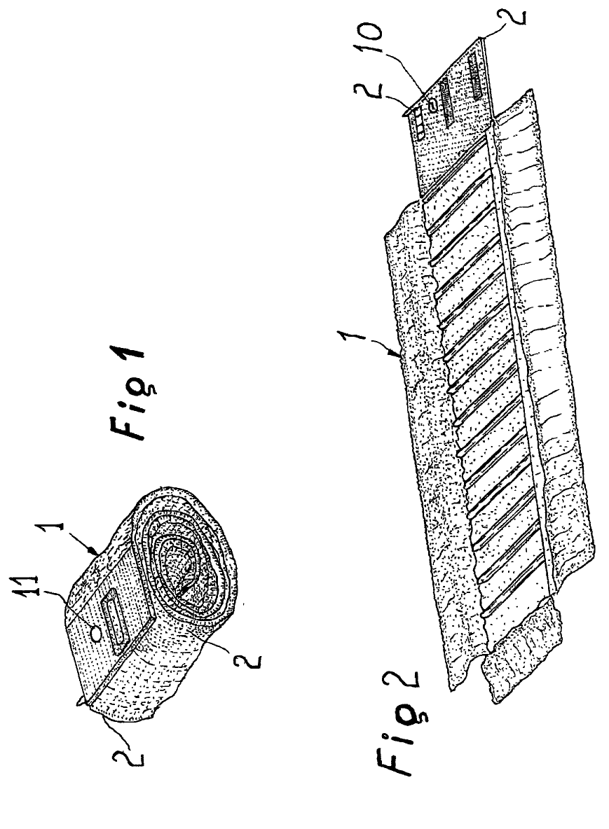

FIG. 1 is a diagrammatic perspective view of a fully rolled up roll-up jewellery case;

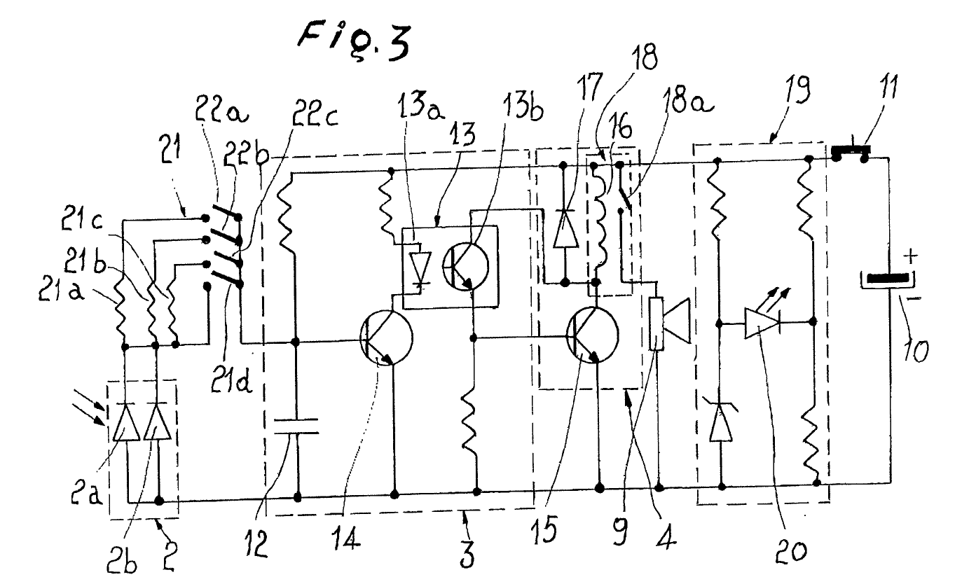

FIG. 2 is a perspective view of the roll-up case shown in FIG. 1 when unrolled or open;

FIG. 3 shows a circuit diagram for a first embodiment of a security device according to the present invention;

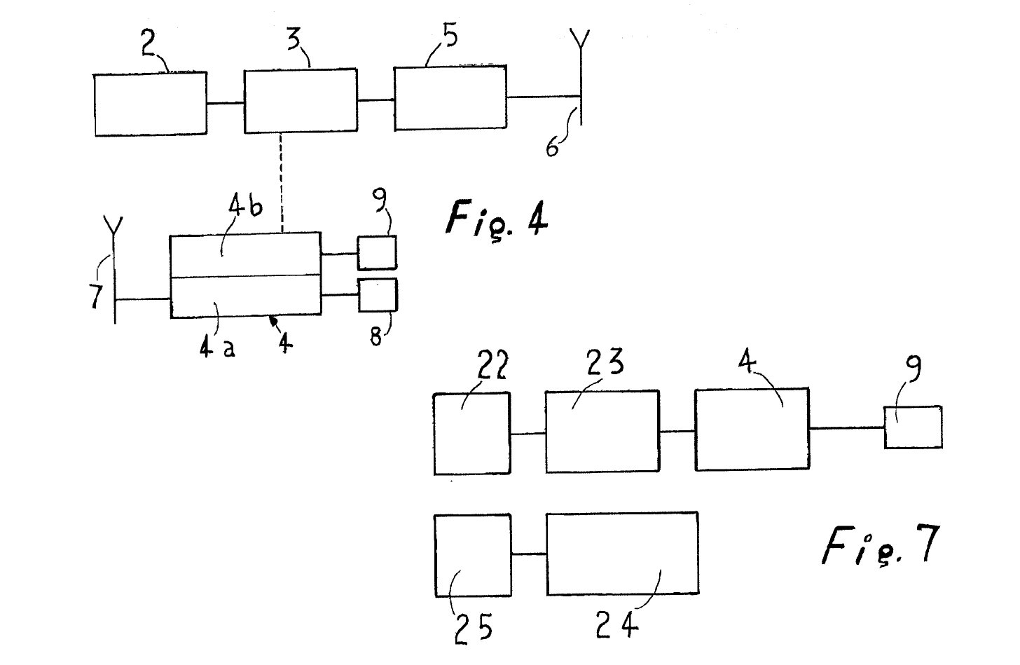

FIG. 4 is a block diagram of a security device according to the present invention;

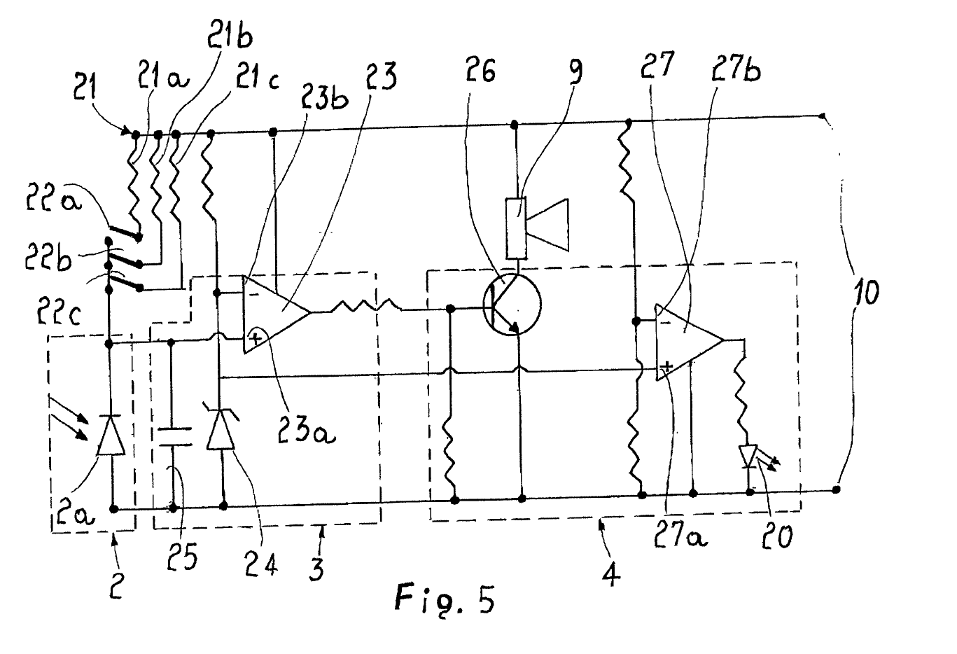

FIG. 5 is a circuit diagram for a second embodiment of the security device according to the present invention;

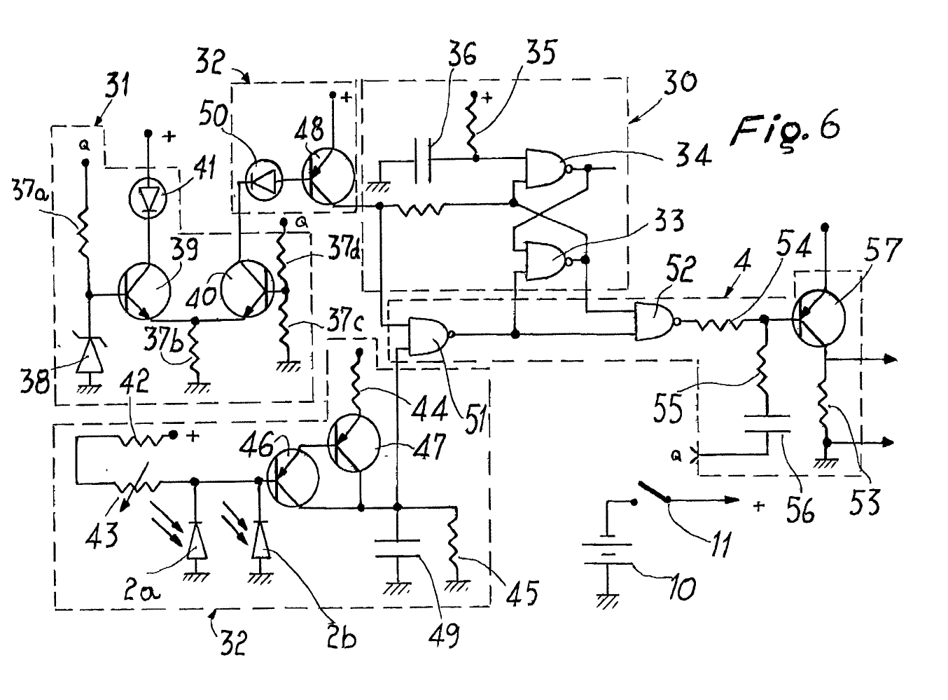

FIG. 6 is a circuit diagram for a another embodiment of the present invention; and

FIG. 7 shows a block diagram of a device according to the present invention using emitters and infrared sensors.

The same or similar parts in the drawings have been indicated with the same reference numerals.

With reference firstly to the above-listed Figures and to FIG. 4 in particular, it will be seen that a security device for valuables cases 1 comprises a light-responsive device, in this case a light sensor 2, installed, as can be seen in more detail in FIG. 2, in a valuables case and electrically connected to a control means 3, further described in detail below.

The control means 3 can be connected to a control device 4 for an alarm system (8, 9).

Such a control device 4, in the embodiment illustrated in the block diagram of FIG. 4, is located outside the valuables case so in this instance there must be a transmitter unit in the valuables case consisting of a control device 5 and a transmitter 6 controlled by the light sensor's control device 3.

Of course, the control device 4a, in this embodiment, is connected to a receiver 7 that receives signals transmitted across the airways by the transmitter unit 6.

According to a further aspect of the invention, the valuables case 1 has one or more satellite transmitters that, once energized, e.g. by means of a signal sent across the airways from inside the jewellery shop, to enable the roll-up case position to be identified if taken out of the jewellery shop.

A security device according to the present invention can of course have both of the alarm systems and in particular the light-responsive device to prevent the roll-up eases being hidden and taken out of the jewellery shop with the jeweller remaining unawares, and a satellite transmitter that enables the roll-up cases to be tracked if they are stolen, by burglary or robbery, and taken outside the shop building.

FIGS. 1 and 2 particularly show an embodiment of the security device according to the present invention applied to a roll-up valuables case 1. In this embodiment both the alarm control and the alarm itself, e.g. a siren, are located in the valuables case itself.

The valuables case 1 is provided with one or more light sensors 2 advantageously arranged at the two edges of the case 1.

The light sensors 2 can be energized by the use of a key, that can be preferably customised, for opening and closing a switch 11 that permits connection of the safety device to an electric power source, e.g. a battery 10 (FIG. 3).

Once the light sensor 2 is activated it is electrically connected to a number of electrical circuits and when there is a sudden drop in light intensity in the surrounding environment (the jewellery shop), as would occur there were an attempt to hide the valuables case in clothing, a circuit closes down as will be explained particularly in the references to FIGS. 3, 5 and 6, with resulting activation of the alarm system, e.g. a sounder.

In further detail, as a first embodiment of the invention as illustrated in FIG. 3, the security device according to the present invention comprises a battery 10 that can be connected, by switching the switch 11 using a customised key, to an electronic device activated by two photodiodes 2a and 2b, that are themselves connected in parallel and constitute the light sensor 2.

Since a photodiode is an electronic reverse-bias component and is constructed with a small transparent window that permits the light to strike an internal junction, when this component is in fact struck by light from a light source it is crossed by an inverse current, while in the absence of light such inverse current crossing it is negligible.

The light sensor 2 is connected to light sensor control means 3 that consists, in this embodiment, of a condenser 12 that is in turn connected via a transistor 14 to a photocoupler 13 comprising a diode 13a and a transistor 13b. Such a control means 3 further comprises a second transistor 14 whose collector is connected to the diode 13a.

The control means 3 is connected to a control device 4 comprising a third transistor 15 whose base is connected to the transistor 13b and whose collector is connected to an inductor 16 in parallel with a diode 17.

Moreover, the collector of the transistor 15, and thus the inductor 16 and the diode 17, are connected to the collector of the transistor 13b.

When the relay 18 closes it permits a siren 19 to be supplied with current and this emits a sound alarm,

Between the switch 11 and the control device 4, a light signalling unit 19 that displays the level of charge in the battery 10 can be advantageously inserted. Such a unit, in detail, comprises two bridges with three resistors and a rectifier connected together via a LED 20.

From the point of view of the device constructor, if it is desired to control the alarm by means of a control system located outside the valuables case, it is no longer necessary to use a circuit-closing relay 18 since the inductor 16 and switch 18a, that make up the relay itself, can be replaced by a signal generator and a transmitter, e.g. an antenna

If required, the security device can also have a sensitivity selector 21 comprising a plurality of resistors 21a, 21b and 21c haling current passing resistance characteristics that are different from each other, and that can, depending on requirements and by closing switches 22a, 22b, 22c and 22d, be connected by the user in series with the photodiodes 2 to adapt the sensitivity of the device according to the present invention to the actual environment lighting levels found in the room, shop etc.

Once the circuit is closed and therefore activated by the switching of the switch 11, where the valuables case is struck by a certain quantity of environment light, the photodiodes 2a and 2b are crossed by a current that denies the transistor 14 supply, this acting as a switch.

If there is a fall in light levels from the environment to the light sensors below a predetermined threshold, e. g. where the valuables case in which the security device is installed is hidden beneath clothing with a view to its theft, the photodiodes stop current flowing with the result that voltage at the base of the transistor 14 is altered, this latter acting as a switch, permitting the current to flow in the photocoupler 13.

Under these conditions the photocoupler 13 opens the switch (transistor) 15 that causes the switch 18a to close owing to the magnetic field generated by the inductor 16.

If the sounder or burglar alarm is not physically located on the valuables case, or if an additional alarm system is associated with the sound alarm system on the case, such additional system being for example one blocking off the shop exits, a transmitter unit (5, 6) must be provided on the valuables case, that communicates with a receiver 7 located in such place that it can receive the transmitter's signal and, through control systems, control the alarm system for example.

According to a second embodiment of the present invention, as shown in more detail in FIG. 5, the security device can comprise advantageously operational integrated circuits.

The light sensor 2, in this case consisting of a single photodiode 2a, is connected to control means 3 that comprises a first operational amplifier 23 that has the function of comparing a stable voltage, as established by a zener diode 14, with the voltage at the ends of the photodiode 2a. The photodiode 2a has, advantageously, a condenser 25 in parallel designed to extend the circuit response time so as to avoid false alarms from brief obscuring of light sensors.

The output from the operational amplifier 23 is connected to the control device 4 and, in particular, said output is connected to the base of a transistor 26, whereas the collector of the transistor itself is connected to an alarm, e.g. a siren 9.

The control device 4 further comprises a second operational amplifier 27 with a non-inverting input 27a connected to the zener diode 24 and its inverting input 27b connected to the battery 10. The output of said second operational amplifier 27 is connected to a LED diode 20.

When voltage at the non-inverting input 23a of the operational amplifier 23 exceeds the voltage at the inverting input 23b, the amplifier takes the output to a high voltage level to permit polarisation of the transistor 26 that, in its turn becomes conducting and supplies voltage to the siren 9 thus activating the alarm that also in this case is a sound alarm.

The second operational amplifier 27 is also used to compare the stable voltage applied to the non-inverting input 27a at the end of the zener diode 24 with the voltage of the battery 10, in such a way that he fall in the battery voltage will lead to a high output voltage level of the amplifier itself with the resulting lighting on of the LED diode 20.

This embodiment can also advantageously be provided with a sensitivity selector 27.

According to a further embodiment of the security device according to the present invention, as illustrated in the circuit diagram of FIG. 6, the device has a sequencer device 30, a battery control circuit 31, a light detection and control circuit 32, and a control device 4.

More particularly, the sequencer 3 comprises a flip-flop comprising two logic NAND-type gates 33 and 34, a resistor 35 and a condenser 36.

The battery control circuit 31 comprises four resistors 37a, 37b, 37c and 37d, a zener diode 38 and two transistors 39 and 40, as well as a LED 41.

The luminosity detection and control circuit 32 includes four resistors 42, 43, 44 and 45, two photodiodes 2a and 2b connected in parallel to each other, three transistors 46, 47 and 48, a condenser 49 and a LED 50.

The control device 4 comprises two logic NAND-type gates 51 and 52, three resistors 53, 54 and 55, a condenser 56 and a transistor 57,

The security device according to the present invention is activated by closing switch 11, thereby supplying voltage to the whole of the electric circuit.

In the first stage the sequencer 3 sends a signal to the battery control circuit 31 that, where the battery's own voltage is below a determined value, causes the LED 38 to light up. At the same time, the luminosity detection circuit 32 checks the luminosity in the environment and, if the light levels are insufficient, causes the LED 46 to light up.

If this check is also successfully passed, the sequencer 3 sends a signal to the control device 4 that energizes, for a fraction of a second, the siren in order to check that it is working.

It is only at this point that the true alarm is activated still by the sequencer 3, when there is a sudden drop in luminosity at the photodiodes 2a and 2b for a determined length of tie.

As can be seen more clearly in the block diagram in FIG. 8, the security device according to the invention can, instead of the light sensors 2, infrared sensors 22 connected by means of an infrared receiver 23 to the control device 4 of the alarm 9, that in the embodiment illustrated in FIG. 5, is an acoustic type of alarm.

In this case, of course, an infrared transmitter 24 has to be installed along with an emitter 25 at each sales or display counter.

Of course, if all or a part of the alarm system is located outside of the valuables case, it is possible to connect such an alarm system to several valuables cases, thus much reducing the costs involved.

It has been found in practice how the security device according to the present invention makes it possible to immediately expose the thief and locate him as the case may be.

Moreover, the security device is highly efficient and reliable while being quite inexpensive to manufacture.

The security device particularly, though not exclusively, for portable valuables cases such as jewellery, cash and similar as described above can be changed and modified within the scope as defined by the appending claims.

The disclosures in Italian patent application No. VR2001A000007 from which this application claims priority are incorporated herein by reference.

Any reference sign following technical features in any claim has been provided to increase intelligibility of the claim and shall not be contrued as limiting the scope of the claim.

1. A security device particularly suitable for a valuables case, having at least one electric power source (10, 31) and alarm system (8, 9) electrically connected to said power source (10, 31), chearacterised in that it comprises at least one light-responsive means (2, 32) that is installed in a valuables case (1) and is energized by the said electric power source (10, 31) upon control and by a change in environment lighting conditions, whereby generating at least one control signal for energizing the said alarm system (8, 9).

2. A security device according to claims 1, characterised in that it comprises a key for the activation of said light-responsive device (2, 32).

3. A security device according to claim 2, characterised in that it comprises a control means (3) for said light-responsive device (2, 32).

4. A security device as claimed in any preceding claim, characterised in that it comprises a signal tramsmitter unit (6) installed in said valuables case (1) and a receiving unit (7) arranged to receive signals transmitted by said transmitter unit (6).

5. A security device according to claim 4, characterised in that the said transmitter unit (6) is satellite transmitter unit controlled by said control means (3).

6. A security device according to claim 5 or 4, characterised in that said light-responsive device comprises a luminosity levels sensor.

7. A security device according to claim 6, characterised in that said luminosity level sensor comprises at least one photodiode (2a, 2b).

8. A security device according to any preceding claim 5 to 7, characterised in that said control means (3) comprises a photocoupler (13) including a diode (13a) and a transistor (13b), said diode (13a) being connected to the or to each light-responsive means (2), said transistor (13b) being connected to a control device (4) controlled by said photocoupler (13) depending on the behaviour of said light-responsive means (2).

9. A security device according to claim 5, characterised in that said control means (3) comprises and inductor (16) designed to generate a magnetic field.

10. A security device according to any preceding claim, characterised in that said alarm system (8, 9) comprises a sounder alarm and a door locking system.

11. A security device according to any preceding claim, characterised in that said alarm system (8, 9) is a remotely controlled system.

12. A security device according to any preceding claim, characterised by the fact that said control means (3) comprises a first operational amplifier (23).

13. A security device according to any preceding claim, characterised in that said control device (4) comprises a second operational amplifier (27).

14. A security device according to any preceding claim, characterised in that it comprises a sequencer means (30).

15. A security device according to claim 14, characterised in that said sequencer means comprises two logic NAND-type ports.

16. A security device according to any preceding claim, characterised in that said light-responsive means (2, 32) comprises an infrared sensor (22).

17. A security device according to claim 16, characterised in that it comprises an infrared emitter (24) located at a sales or display counter.

18. A security device according to any preceding claim, characterised in that it comprises luminosity detection circuit (32) indicating the electric power source charge level.

19. A security device according to any preceding claim, characterised in that it comprises a sensitivity selector (21) for the or for each of the light-responsive means (2, 32).
